(19) United States
(12) Patent Application Publication
(10) Pub. No.: US 2026/0260169 A1
(43) Pub. Date: Sep. 3, 2026

(54) LARGE LANGUAGE MODEL (LLM) TRAINING METHOD AND APPARATUS, DEVICE, AND STORAGE MEDIUM

(71) Applicant: THE FIFTH AFFILIATED HOSPITAL OF GUANGZHOU MEDICAL UNIVERSITY, Guangzhou (CN)

(72) Inventors: Bin Li, Guangzhou (CN); Zhenyu Gao, Guangzhou (CN); Zhihui Lin, Guangzhou (CN); Songqi He, Guangzhou (CN); Weijian Liu, Guangzhou (CN); Zhitao Deng, Guangzhou (CN)

(21) Appl. No.: 19/641,579

(22) Filed: Apr. 8, 2026

Related U.S. Application Data
(63) Continuation-in-part of application No. PCT/CN2025/125033, filed on Sep. 28, 2025.

(30) Foreign Application Priority Data
Mar. 3, 2025 (CN) 202510242020.8

(51) Int. Cl. G06N 20/00; G10L 15/22

(52) U.S. Cl. CPC G06N 20/00; G10L 15/22

(57) ABSTRACT

Provided are a large language model (LLM) training method and apparatus, a device, and a storage medium. The method includes: acquiring a corpus data training set to be trained, and selecting corpus data from the corpus data training set; predicting the corpus data by using an LLM, obtaining a prediction result, calculating a current loss value based on the prediction result, saving the current loss value, and calculating a current preset loss value based on the saved current loss value; and determining whether the current loss value is less than the current preset loss value; if yes, skipping updating model parameters of the LLM; if not, updating the model parameters of the LLM and the current preset loss value based on the current loss value, re-selecting corpus data from the corpus data training set, and continuing to update the model parameters of the LLM until a trained LLM is obtained.

### CROSS-REFERENCE TO RELATED APPLICATION

This application is a continuation-in-part of PCT Patent Application No. PCT/CN2025/125033, filed on Sep. 28, 2025. This application claims priority to Chinese Patent Application No. 202510242020.8, filed with the China National Intellectual Property Administration (CNIPA) on Mar. 3, 2025 and entitled “LARGE LANGUAGE MODEL (LLM) TRAINING METHOD AND APPARATUS, DEVICE, AND STORAGE MEDIUM”. Both of the foregoing applications are incorporated herein by reference in their entireties.

### TECHNICAL FIELD

The present disclosure relates to the technical field of large language models (LLMs), and specifically, to an LLM training method and apparatus, a device, and a storage medium.

### BACKGROUND

Pre-training of a large language model (LLM) is a complex and resource-intensive process that involves using a vast amount of data to perform model training to enable the LLM to understand and generate natural language text. As one of core stages in LLM training, the pre-training allows the LLM to learn a statistical pattern, semantic information, and a contextual relationship of language by processing large-scale unannotated text data. A pre-training dataset is typically enormous, containing billions or even trillions of words sourced from the Internet, books, academic papers, and other materials. During the pre-training, the LLM usually learns an association between words and a sentence structure by using a self-supervised learning method, for example, by predicting a covered or masked text segment. This approach can make full use of abundant unlabeled data and improve a generalization capability of the LLM. However, the pre-training incurs a high cost and requires extensive computational resources and time. Additionally, challenges of the LLM, such as inference latency, context length limitations, and instability in evaluation methods, also need to be addressed during the pre-training.

The following mainstream methods are currently available. In a first method, before the training, a required data type, data volume, and quality requirement are understood. Data cleaning is performed to remove noise and outliers. A specialized text scoring model is constructed to filter out high-quality data. In a second method, open-source and closed-source LLMs and pre-training data are used to enable these LLMs to generate high-quality data, thereby condensing the pre-training data into high-quality data and reducing a proportion of junk data. In a third method, in the patent CN118171108A, model pre-training data is shuffled and then divided into blocks that are sorted based on a text data length, which reduces dataset randomness, improves model training efficiency, and lowers a training cost. However, the above methods merely involve data sorting without enhancing data quality, resulting in a limited improvement to performance of the LLM.

### SUMMARY

To address the aforementioned technical problems, embodiments of the present disclosure provide an LLM training method and apparatus, a device, and a storage medium, which solve a problem of low performance of a resulting LLM caused by poor training data quality in existing LLM training processes.

A first aspect of the embodiments of the present disclosure provides an LLM training method, including:
acquiring a corpus data training set to be trained, and selecting corpus data from the corpus data training set;
inputting the corpus data into an LLM for prediction, obtaining a prediction result, calculating a current loss value by using a cross-entropy loss function based on the prediction result, saving the current loss value, and calculating a current preset loss value based on the saved current loss value;
determining whether the current loss value is less than the current preset loss value; and in response to that the current loss value is less than the current preset loss value, skipping updating model parameters of the LLM;
in response to that the current loss value is greater than the current preset loss value, updating the model parameters of the LLM based on the current loss value, re-selecting new corpus data from the corpus data training set, continuing to update the model parameters of the LLM based on the new corpus data until updated model parameters meet a first preset condition, and obtaining a trained LLM;
collecting a voice signal from a user;
inputting the voice signal into the trained LLM, and obtaining a voice recognition result; and
controlling a rehabilitation device to start a limb rehabilitation exercise mode corresponding to the voice recognition result.

In a possible implementation of the first aspect, the calculating a current preset loss value based on the saved current loss value includes:
calculating, based on a plurality of saved loss values, a value of an exponential function for each of the plurality of loss values, and obtaining a plurality of values;
performing a normalization operation on each of the plurality of values, obtaining a normalized value corresponding to each of the plurality of values, sorting all normalized values in a descending order, and obtaining a sorting result;
accumulating top N normalized values in the sorting result to obtain a first accumulation result, and accumulating top N+1 normalized values in the sorting result to obtain a second accumulation result, where N is an integer greater than or equal to 1; and
obtaining an initial preset loss value based on the first accumulation result and the second accumulation result, and inverting the initial preset loss value to obtain the current preset loss value.

In a possible implementation of the first aspect, the accumulating top N normalized values in the sorting result to obtain a first accumulation result, and accumulating top N+1 normalized values in the sorting result to obtain a second accumulation result includes:
selecting the top N normalized values in the sorting result to obtain a first target sorting result, and selecting the top N+1 normalized values in the sorting result to obtain a second target sorting result;
determining whether the first target sorting result and the second target sorting result contain a normalized value greater than the current preset loss value; and in response to that the first target sorting result and the second target sorting result contain the normalized value greater than the current preset loss value, removing the normalized value greater than the current preset loss value, and obtaining a new first target sorting result and a new second target sorting result; and
summing all normalized values in the new first target sorting result to obtain the first accumulation result, and summing all normalized values in the new second target sorting result to obtain the second accumulation result.

In a possible implementation of the first aspect, the obtaining an initial preset loss value based on the first accumulation result and the second accumulation result includes:
subtracting the second accumulation result from the first accumulation result, and obtaining the initial preset loss value.

In a possible implementation of the first aspect, the re-selecting new corpus data from the corpus data training set includes:
selecting, from the corpus data training set to be trained, the corpus data that has not been trained; or
selecting, from corpus data whose loss value is less than the current preset loss value, corpus data that meets a second preset condition.

A second aspect of the embodiments of the present disclosure provides an LLM training apparatus, including:
an acquisition module configured to acquire a corpus data training set to be trained, and select corpus data from the corpus data training set;
a loss value calculation module configured to input the corpus data into an LLM for prediction, obtain a prediction result, calculate a current loss value by using a cross-entropy loss function based on the prediction result, save the current loss value, and calculate a current preset loss value based on the saved current loss value;
a first determination module configured to determine whether the current loss value is less than the current preset loss value; and in response to that the current loss value is less than the current preset loss value, skip updating model parameters of the LLM;
a second determination module configured to: in response to that the current loss value is greater than the current preset loss value, update the model parameters of the LLM based on the current loss value, re-select new corpus data from the corpus data training set, continue to update the model parameters of the LLM based on the new corpus data until updated model parameters meet a first preset condition, and obtain a trained LLM;
a collection module configured to collect a voice signal from a user;
an input module configured to input the voice signal into the trained LLM, and obtain a voice recognition result; and
a control module configured to control a rehabilitation device to start a limb rehabilitation exercise mode corresponding to the voice recognition result.

In a possible implementation of the second aspect, the loss value calculation module includes a selection unit, a normalization unit, an accumulation unit, and a calculation unit, where

the selection unit is configured to calculate, based on a plurality of saved loss values, a value of an exponential function for each of the plurality of loss values, and obtain a plurality of values;
the normalization unit is configured to perform a normalization operation on each of the plurality of values, obtain a normalized value corresponding to each of the plurality of values, sort all normalized values in a descending order, and obtain a sorting result;
the accumulation unit is configured to accumulate top N normalized values in the sorting result to obtain a first accumulation result, and accumulate top N+1 normalized values in the sorting result to obtain a second accumulation result, where N is an integer greater than or equal to 1; and
the calculation unit is configured to obtain an initial preset loss value based on the first accumulation result and the second accumulation result, and invert the initial preset loss value to obtain the current preset loss value.

In a possible implementation of the second aspect, the accumulation unit includes a sorting subunit, a screening subunit, and a sorting result accumulation subunit, where
the sorting subunit is configured to select the top N normalized values in the sorting result to obtain a first target sorting result, and select the top N+1 normalized values in the sorting result to obtain a second target sorting result;
the screening subunit is configured to determine whether the first target sorting result and the second target sorting result contain a normalized value greater than the current preset loss value; and in response to that the first target sorting result and the second target sorting result contain the normalized value greater than the current preset loss value, remove the normalized value greater than the current preset loss value, and obtain a new first target sorting result and a new second target sorting result; and
the sorting result accumulation subunit is configured to sum all normalized values in the new first target sorting result to obtain the first accumulation result, and sum all normalized values in the new second target sorting result to obtain the second accumulation result.

A third aspect of the embodiments of the present disclosure provides a computer device, including:
a memory configured to store a computer program; and
a processor configured to execute the computer program to implement the LLM training method in the first aspect.

A fourth aspect of the embodiments of the present disclosure provides a non-transitory computer-readable storage medium, where the non-transitory computer-readable storage medium stores a computer program, and the computer program is executed by a processor to perform steps of the LLM training method in the first aspect.

Compared with the prior art, the present disclosure has the following beneficial effects:
The LLM training method provided in the embodiments of the present disclosure acquires a corpus data training set to be trained, and selects corpus data from the corpus data training set; predicts the corpus data by using an LLM, obtains a prediction result, and calculates a loss value by using a cross-entropy loss function based on the prediction result; determines whether the loss value is less than a current preset loss value; in response to that the loss value is less than the current preset loss value, skips updating model parameters of the LLM; and in response to that the loss value is greater than the current preset loss value, updates the model parameters of the LLM and the current preset loss value based on the loss value, re-selects corpus data from the corpus data training set, continues to update the model parameters of the LLM based on the re-selected corpus data until updated model parameters meet a first preset condition, and obtains a trained LLM. According to the above method, the loss value of the corpus data is calculated to determine whether the corpus data can be used for training, which improves quality of training data and enhances performance of the LLM. Furthermore, in a practical application, a voice signal is collected from a user and input into the trained LLM, such that a voice recognition result can be obtained. Then, a rehabilitation device is controlled to start a limb rehabilitation exercise mode corresponding to the voice recognition result, to assist the user in performing a limb rehabilitation exercise, thereby facilitating recovery of a limb function of the user.

### BRIEF DESCRIPTION OF THE DRAWINGS

FIG. 1 is a flowchart of an LLM training method according to an embodiment of the present disclosure;

FIG. 2 is a flowchart of an LLM training method according to an embodiment of the present disclosure;

FIG. 3 is a structural block diagram of an LLM training apparatus according to an embodiment of the present disclosure;

FIG. 4 is a structural block diagram of a loss value calculation module according to an embodiment of the present disclosure; and

FIG. 5 is a structural block diagram of an accumulation unit according to an embodiment of the present disclosure.

### DETAILED DESCRIPTION

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts should fall within the protection scope of the present disclosure.

It should be understood that step numbers used in this specification are only intended to facilitate description, and are not used to limit a sequence of steps.

It should be understood that the terms used in this specification of the present disclosure are for the purpose of describing specific embodiments only and are not intended to limit the present disclosure. As used in this specification of the present disclosure and the appended claims, the singular forms “a”, “an” and “the” are intended to include the plural forms unless the context clearly indicates otherwise.

The terms “include”, “contain”, and “comprise” indicate the existence of the described feature, entity, step, operation, element and/or component, but do not exclude the existence or addition of one or more other features, entities, steps, operations, elements, components and/or a combination thereof.

The term “and/or” refers to one of or any combination or all possible combinations of more of items listed in association, and includes these combinations.

The term “a plurality of” refers to two or more.

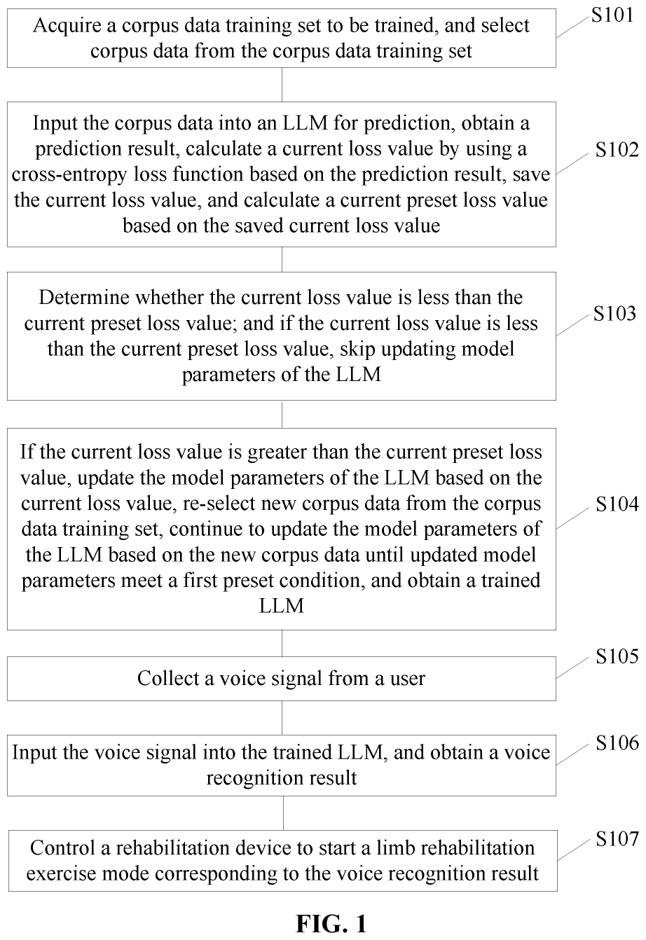

Therefore, a schematic flowchart of an LLM training method according to an embodiment of the present disclosure is shown in FIG. 1. The LLM training method includes steps S101 to S107, which are specifically described as follows:
S101: Acquire a corpus data training set to be trained, and select corpus data from the corpus data training set.

In this embodiment, pre-training data of an LLM is obtained from various sources such as the Internet, books, and academic papers, and a corpus data training set is obtained. A pre-training dataset of the LLM is typically enormous, containing billions or even trillions of words. The diversity and scale of data are crucial for obtaining a high-performance LLM through training. During the training, corpus data is selected from the corpus data training set and input into the LLM.

S102: Input the corpus data into the LLM for prediction, obtain a prediction result, calculate a current loss value by using a cross-entropy loss function based on the prediction result, save the current loss value, and calculate a current preset loss value based on the saved current loss value.

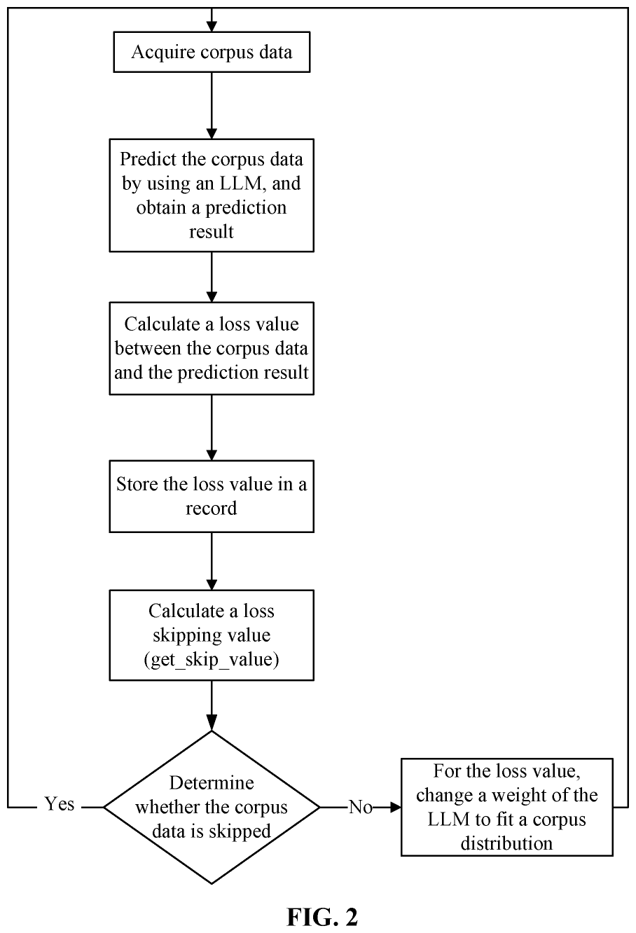

In this embodiment, as shown in FIG. 2, the selected corpus data is input into the LLM for prediction, the prediction result is obtained, and the current loss value is calculated by using the cross-entropy loss function based on the prediction result.

At present, cross-entropy plays a crucial role in training most LLMs. The cross-entropy is a commonly used loss function in natural language processing, particularly in a language model. The cross-entropy measures a difference between a probability distribution predicted by the model and a true probability distribution. In the LLM, the cross-entropy loss function is used to optimize model parameters, enabling the model to better predict a probability of a next word or marker. By minimizing a cross-entropy loss, the model learns to adjust its parameters to improve accuracy of predicting a true data distribution.

For two discrete probability distributions P and Q, the cross-entropy is defined as a mathematical expression of the cross-entropy loss function, namely:

$$H ( P , Q ) = - {\sum }_{x} P ( x ) log Q ( x )$$

In the above expression, P represents a true probability distribution of the corpus data, Q represents a probability distribution in a prediction result of the LLM, and x represents the corpus data.

The LLM performs learning by predicting a next word in a sentence. During the training, the model is trained to minimize a difference between a predicted word and an actual word. Therefore, the cross-entropy acts as a loss function that guides the model to adjust its parameters to produce a higher-quality prediction. By minimizing the cross-entropy, the LLM becomes increasingly adept at generating coherent and contextually relevant text that is very similar to a human language pattern.

Generally, the corpus data training set contains tens of billions or even trillions of pieces of corpus data used for model training. In model training and inference processes, each piece of corpus data is processed by the LLM to obtain a prediction result, and a loss value obtained for the loss function based on the prediction result varies accordingly. A high loss value for a piece of corpus data indicates a large difference between a predicted value and an actual value, and a low loss value for a piece of corpus data indicates a small difference between a predicted value and an actual value.

However, it has been found during LLM training that the loss value can be used as a criterion for determining corpus quality. During the LLM training, the LLM itself gradually learns a corpus pattern and becomes familiar with a distribution of the corpus data. Thus, the model can calculate a loss value of the loss function for a piece of corpus data to determine whether the piece of corpus data should participate in the training. If the loss value of the loss function is low, it indicates that the piece of corpus data is of poor quality and may contain a large amount of easily predictable data, many formatted or repetitive tokens, or relatively limited token variations. Therefore, corpus data with a low loss value can be skipped during the training, thereby improving performance of the LLM training.

In some embodiments, the calculating a current preset loss value based on the saved current loss value in the step S102 includes but is not limited to the following steps:
calculating, based on a plurality of saved loss values, a value of an exponential function for each of the plurality of loss values, and obtaining a plurality of values;
performing a normalization operation on each of the plurality of values, obtaining a normalized value corresponding to each of the plurality of values, sorting all normalized values in a descending order, and obtaining a sorting result;
accumulating top N normalized values in the sorting result to obtain a first accumulation result, and accumulating top N+1 normalized values in the sorting result to obtain a second accumulation result, where N is an integer greater than or equal to 1; and
obtaining an initial preset loss value based on the first accumulation result and the second accumulation result, and inverting the initial preset loss value to obtain the current preset loss value.

In this embodiment, during the LLM training, a loss value of each piece of corpus data is obtained and then recorded. A skip_value, namely the current preset loss value, is reached by using a get_skip_value function in code based on the stored loss value. If a loss value of currently trained corpus data is less than the skip_value, the model will not include the currently trained corpus data in backpropagation of the training, that is, the currently trained corpus data will not affect a weight change of the model training, which is equivalent to skipping the currently trained corpus data and excluding it from a current training consideration. If the loss value of the currently trained corpus data is greater than the skip_value, the currently trained corpus data is included in normal training.

It should be noted that the loss value is a loss value obtained by the cross-entropy loss function.

Specifically, in written pseudo-code, all the first t loss values recorded in a record array are extracted, and values of their exponential functions with a natural constant e as a base are calculated. The obtained values are then accumulated to obtain an accumulated value. The normalization operation is performed on each value by using the accumulated value, and a new array is obtained. A sum of values in the array is 1. For example, if the top three loss values 0.8, 0.8, and 0.9 are extracted, and exponential operations are respectively performed on the three loss values, such as e^{0.8}, e^{0.8}, and e^{0.9}. The above results are summed, namely e^{0.8}+e^{0.8}+e^{0.9}, and then the normalization operation is performed, for example, e^{0.8}/(e^{0.8}+e^{0.8}+e^{0.9}). Subsequently, normalized values in the new array are sorted in the descending order to obtain a probs array, which stores normalized values sorted in the descending order.

A cum_sum_probs function is constructed, and top-ranked normalized values in the probs array are accumulated, for example:

cum_sum_probs[3]=sort_probs[1]+sort_probs[2]+sort_probs[3]

As described above, cum_sum_probs[3] represents an accumulation result of the top 3 normalized values in a sorting result, and sort_probs[N] represents an N^{th} normalized value in the sorting result.

After an accumulation result of the top-ranked normalized values is obtained, the initial preset loss value is obtained based on the accumulation result, and then is inverted to obtain the current preset loss value.

It should be noted that a value of a parameter p is the current preset loss value (i.e., the skip_value). A suitable skip_value for the current model is selected by counting historical loss patterns. The parameter p is variable and generally takes a value between 0.5 and 0.8.

Herein, the inversion refers to conversion of a probability value (prob) into a corresponding loss value (loss) through a mapping relationship (i.e., a prob_to_loss function), which is essentially a reverse mapping calculation from a probability to a loss. In the model training, the loss (loss) is usually calculated first, and then parameter updating is performed through the backpropagation to minimize the loss. However, the prob_to_loss function works in an opposite way. That is, given a probability (prob) of a certain event, the prob_to_loss function infers a corresponding loss value of the probability through a specific functional relationship.

In some embodiments, the accumulating top N normalized values in the sorting result to obtain a first accumulation result, and accumulating top N+1 normalized values in the sorting result to obtain a second accumulation result includes:
selecting the top N normalized values in the sorting result to obtain a first target sorting result, and selecting the top N+1 normalized values in the sorting result to obtain a second target sorting result;
determining whether the first target sorting result and the second target sorting result contain a normalized value greater than the current preset loss value; and if the first target sorting result and the second target sorting result contain the normalized value greater than the current preset loss value, removing the normalized value greater than the current preset loss value, and obtaining a new first target sorting result and a new second target sorting result; and
summing all normalized values in the new first target sorting result to obtain the first accumulation result, and summing all normalized values in the new second target sorting result to obtain the second accumulation result.

In this embodiment, the top N normalized values in the sorting result are selected and accumulated to obtain an accumulation result, namely cum_sum_probs[N]. The top N+1 normalized values in the sorting result are selected and accumulated to obtain an accumulation result, namely cum_sum_probs[N+1]. During the accumulation, the cum_sum_probs[N] and the cum_sum_probs[N+1] are split by using the input parameter p. For example, if p=0.8, a value greater than 0.8 in the cum_sum_probs[N] and the cum_sum_probs[N+1] is discarded, thereby obtaining a final accumulation result.

In some embodiments, the obtaining an initial preset loss value based on the first accumulation result and the second accumulation result includes but is not limited to the following step:
subtracting the second accumulation result from the first accumulation result, and obtaining the initial preset loss value.

In this embodiment, after a final accumulation result of the top N normalized values in the sorting result and a final accumulation result of the top N+1 normalized values in the sorting result are obtained, the initial preset loss value is obtained by subtracting the final accumulation result of the top N+1 normalized values from the final accumulation result of the top N normalized values. For example, the prob can be obtained by subtracting cum_sum_probs[2] from cum_sum_probs[1], namely the initial preset loss value. The initial preset loss value is then inverted into the loss value through the prob_to_loss function, namely the current preset loss value. Finally, the loss value is returned.

S103: Determine whether the current loss value is less than the current preset loss value; and if the current loss value is less than the current preset loss value, skip updating model parameters of the LLM.

In this embodiment, if a loss value of the corpus data is less than the skip_value, the corpus data is not included in the backpropagation of the training, and the corpus data with a low loss value is skipped. Furthermore, in some embodiments, if the loss value of the corpus data is equal to the skip_value, the corpus data is not included in the backpropagation of the training, and the corpora with a low loss values is skipped.

S104: If the current loss value is greater than the current preset loss value, update the model parameters of the LLM based on the current loss value, re-select new corpus data from the corpus data training set, continue to update the model parameters of the LLM based on the new corpus data until updated model parameters meet a first preset condition, and obtain a trained LLM.

In this embodiment, if the loss value of the corpus data is greater than the skip_value, the corpus data is included in the backpropagation of the training. In this case, the model parameters of the LLM are updated. After an updated LLM is obtained, the new corpus data is re-selected from the corpus data training set, the model parameters of the LLM are continuously updated based on the new corpus data until the updated model parameters meet the first preset condition, and the trained LLM is obtained.

The first preset condition may be some specific evaluation indicators that are set based on commonly used convergence conditions in the field or based on application scenarios and task requirements of the model, such as an F1 score. When the model reaches preset thresholds or levels of these evaluation indicators, it can be considered that the model training is completed.

In some embodiments, the re-selecting new corpus data from the corpus data training set in the step S104 includes but is not limited to the following steps:
selecting, from the corpus data training set to be trained, corpus data that has not been trained; or
selecting, from corpus data whose loss value is less than the current preset loss value, corpus data that meets a second preset condition.

In this embodiment, when the corpus data is re-selected from the corpus data training set, the corpus data that has not been trained is selected from the corpus data training set to be trained.

Alternatively, the corpus data that meets the second preset condition is selected from the corpus data whose loss value is less than the current preset loss value. This ensures that a certain amount of corpus data with a relatively low loss value of the loss function is also included in the training, so as to prevent the model from forgetting some already learned knowledge.

The second preset condition means that the loss value of the corpus data is less than a preset value. The preset value may be determined based on actual needs and is generally a value less than 0.8 and greater than 0.5, such as 0.8, 0.7, or 0.6.

S105: Collect a voice signal from a user.

In this embodiment, for example, the voice signal from the user can be collected through a microphone.

S106: Input the voice signal into the trained LLM, and obtain a voice recognition result.

S107: Control a rehabilitation device to start a limb rehabilitation exercise mode corresponding to the voice recognition result.

In a specific implementation, the LLM training method can be executed by a processor, and the processor may be a part of the rehabilitation device. The steps S105 to S107 will be described in detail below.

It is found through comparative experimental analysis that when same corpus data is used to pre-train a Transformer-based Llama LLM, the LLM in the embodiments of the present disclosure achieves a significant performance improvement on an evaluation set.

TABLE 1
Evaluation set scores of different LLM training methods

| | | | | MMLU | BBH |
|---|---|---|---|---|---|
| | HellaSwag | Obqa | WinoGrande | (5Shot) | (5Shot) |
| Llama-1.5B | 58.5 | 32.3 | 61.1 | 25.8 | 29.7 |
| Llama-1.5B-Skip | 61.7 | 33.0 | 66.3 | 29.3 | 30.9 |
| (Ours) | | | | | |

The model used is based on a Llama architecture, with a size of 1.5B (1.5 billion parameters). After the model is trained by using the same corpus data and a new algorithm is employed, all evaluation set scores significantly increase, as shown in Table 1, which lists evaluation set scores of training the LLM by using various algorithms.

It should be understood that although the steps in the flowchart shown in FIG. 1 are sequentially displayed according to the arrows, these steps are not necessarily performed in the order indicated by the arrows. An execution order of these steps is not strictly limited, and these steps may be executed in other orders, unless clearly described otherwise. Moreover, at least some steps in FIG. 1 may include a plurality of substeps or a plurality of stages, which are not necessarily executed at a same time point, but may be executed at different time points. These substeps or stages are not necessarily performed sequentially, but may be executed alternately with other steps or at least some substeps or stages of other steps.

In a practical application, the trained LLM can determine whether an emotional tone expressed in the user's input is positive or negative. Certainly, the trained LLM can also be used to control a device to operate, for example, it can be used to control the rehabilitation device to operate. For example, the embodiments of the present disclosure further provide a rehabilitation device control method, including:
collecting a voice signal from a user;
inputting the voice signal into the trained LLM, and obtaining a voice recognition result; and
controlling a rehabilitation device to start a limb rehabilitation exercise mode corresponding to the voice recognition result.

For example, the rehabilitation device includes a processor and a massage apparatus. The massage apparatus offers massage modes such as a level-1 mode, a level-2 mode, and a level-3 mode, which fall under limb rehabilitation exercise modes. Specifically, the level-1 mode corresponds to neck massage, the level-2 mode corresponds to leg massage, the level-3 mode corresponds to back massage, and the like. When the user utters an instruction “level-1 massage”, the processor of the rehabilitation device recognizes the instruction of the user through the trained LLM, and then controls the massage apparatus to execute the level-1 mode, thereby providing massage to the user's neck, which is beneficial for the user's neck rehabilitation exercise. In addition, the rehabilitation device may also include a hand function trainer (such as a hand grip strengthener and a finger dexterity trainer) to assist the user in recovering the user's hand function. The hand function trainer has various limb rehabilitation exercise modes such as a grip exercise mode, a single-finger exercise mode, and a double-finger exercise mode. When the user utters an instruction “grip exercise mode”, the processor of the rehabilitation device recognizes the instruction of the user through the trained LLM, and controls the hand function trainer to execute the grip exercise mode to help the user exercise a hand grip function. Certainly, the rehabilitation device may also include other limb rehabilitation apparatuses.

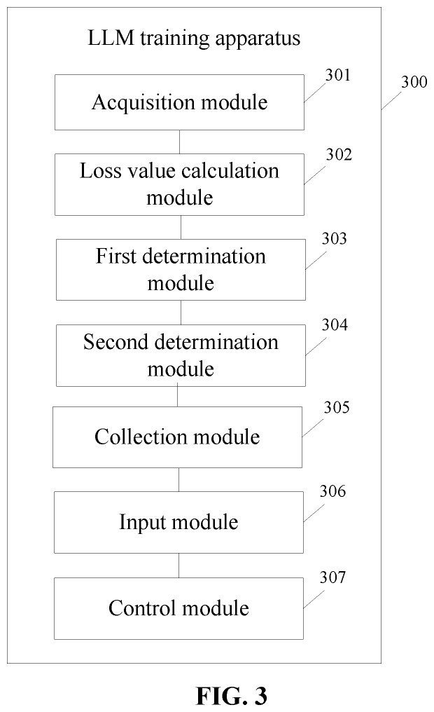

In some embodiments, a block diagram of an LLM training apparatus 300 according to an embodiment of the present disclosure is shown in FIG. 3. The LLM training apparatus 300 includes an acquisition module 301, a loss value calculation module 302, a first determination module 303, a second determination module 304, a collection module 305, an input module 306, and a control module 307.

The acquisition module 301 is configured to acquire a corpus data training set to be trained, and select corpus data from the corpus data training set.

The loss value calculation module 302 is configured to input the corpus data into an LLM for prediction, obtain a prediction result, calculate a current loss value by using a cross-entropy loss function based on the prediction result, save the current loss value, and calculate a current preset loss value based on the saved current loss value.

The first determination module 303 is configured to determine whether the current loss value is less than the current preset loss value; and if the current loss value is less than the current preset loss value, skip updating model parameters of the LLM.

The second determination module 304 is configured to: if the current loss value is greater than the current preset loss value, update the model parameters of the LLM based on the current loss value, re-select new corpus data from the corpus data training set, continue to update the model parameters of the LLM based on the new corpus data until updated model parameters meet a first preset condition, and obtain a trained LLM.

The collection module 305 is configured to collect a voice signal from a user.

The input module 306 is configured to input the voice signal into the trained LLM, and obtain a voice recognition result.

The control module 307 is configured to control a rehabilitation device to start a limb rehabilitation exercise mode corresponding to the voice recognition result.

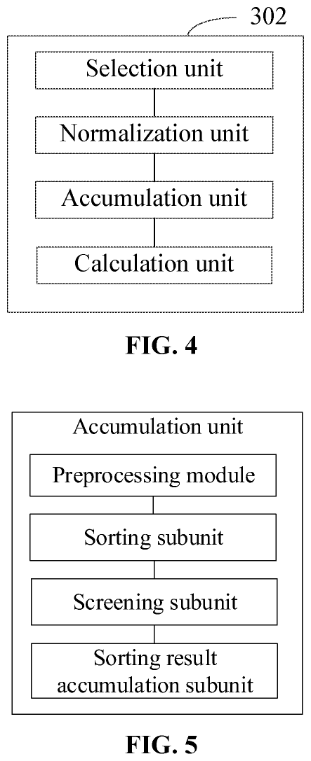

In some embodiments, a structural block diagram of the loss value calculation module according to an embodiment of the present disclosure is shown in FIG. 4. The loss value calculation module 302 includes a selection unit, a normalization unit, an accumulation unit, and a calculation unit, where
the selection unit is configured to calculate, based on a plurality of saved loss values, a value of an exponential function for each of the plurality of loss values, and obtain a plurality of values;
the normalization unit is configured to perform a normalization operation on each of the plurality of values, obtain a normalized value corresponding to each of the plurality of values, sort all normalized values in a descending order, and obtain a sorting result;
the accumulation unit is configured to accumulate top N normalized values in the sorting result to obtain a first accumulation result, and accumulate top N+1 normalized values in the sorting result to obtain a second accumulation result, where N is an integer greater than or equal to 1; and
the calculation unit is configured to obtain an initial preset loss value based on the first accumulation result and the second accumulation result, and invert the initial preset loss value to obtain the current preset loss value.

In some embodiments, a structural block diagram of the accumulation unit according to an embodiment of the present disclosure is shown in FIG. 5. The accumulation unit includes a sorting subunit, a screening subunit, and a sorting result accumulation subunit, where
the sorting subunit is configured to select the top N normalized values in the sorting result to obtain a first target sorting result, and select the top N+1 normalized values in the sorting result to obtain a second target sorting result;
the screening subunit is configured to determine whether the first target sorting result and the second target sorting result contain a normalized value greater than the current preset loss value; and if the first target sorting result and the second target sorting result contain the normalized value greater than the current preset loss value, remove the normalized value greater than the current preset loss value, and obtain a new first target sorting result and a new second target sorting result; and
the sorting result accumulation subunit is configured to sum all normalized values in the new first target sorting result to obtain the first accumulation result, and sum all normalized values in the new second target sorting result to obtain the second accumulation result.

The present disclosure also provides another embodiment of an LLM training apparatus. In this embodiment, the LLM training apparatus includes: a processor, where the processor is configured to execute the following program modules or program units stored in a memory: the acquisition module 301, the loss value calculation module 302, the first determination module 303, the second determination module 304, the collection module 305, the input module 306, the control module 307, the selection unit, the normalization unit, the accumulation unit, the calculation unit, the sorting subunit, the screening subunit, and the sorting result accumulation subunit.

Specific implementations of the LLM training apparatus are basically the same as the specific embodiments of the above LLM training method, and therefore are not described herein again.

In an embodiment of the present disclosure, a computer device is provided, including a memory and a processor. The memory stores a computer program, and the processor executes the computer program to implement the above steps. An implementation principle and a technical effect of the computer device provided in this embodiment are similar to those of the aforementioned method embodiments, and therefore are not described herein again.

In an embodiment of the present disclosure, a computer-readable storage medium is provided. The computer-readable storage medium stores a computer program, and the computer program is executed by a processor to implement the above steps. An implementation principle and a technical effect of the computer-readable storage medium provided in this embodiment are similar to those of the aforementioned method embodiments, and therefore are not described herein again. For example, the computer-readable storage medium provided in this embodiment is a non-transitory computer-readable storage medium.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by this specification as long as no contradiction occurs.

The objectives, technical solutions, and beneficial effects of the present disclosure are further described in detail through the above specific embodiments. It should be understood that the above are merely some specific embodiments of the present disclosure, but are not intended to limit the protection scope of the present disclosure. It should be particularly noted that, any modifications, equivalent substitutions, improvements, and the like made by those skilled in the art within the spirit and principle of the present disclosure should be included within the protection scope of the present disclosure.

1. A large language model (LLM) training method, comprising:
acquiring a corpus data training set to be trained, and selecting corpus data from the corpus data training set;
inputting the corpus data into an LLM for prediction, obtaining a prediction result, calculating a current loss value by using a cross-entropy loss function based on the prediction result, saving the current loss value, and calculating a current preset loss value based on the saved current loss value;
determining whether the current loss value is less than the current preset loss value; and in response to that the current loss value is less than the current preset loss value, skipping updating model parameters of the LLM;
in response to that the current loss value is greater than the current preset loss value, updating the model parameters of the LLM based on the current loss value, re-selecting new corpus data from the corpus data training set, continuing to update the model parameters of the LLM based on the new corpus data until updated model parameters meet a first preset condition, and obtaining a trained LLM;
collecting a voice signal from a user;
inputting the voice signal into the trained LLM, and obtaining a voice recognition result; and
controlling a rehabilitation device to start a limb rehabilitation exercise mode corresponding to the voice recognition result.

2. The LLM training method according to claim 1, wherein the calculating a current preset loss value based on the saved current loss value comprises:
calculating, based on a plurality of saved loss values, a value of an exponential function for each of the plurality of loss values, and obtaining a plurality of values;
performing a normalization operation on each of the plurality of values, obtaining a normalized value corresponding to each of the plurality of values, sorting all normalized values in a descending order, and obtaining a sorting result;
accumulating top N normalized values in the sorting result to obtain a first accumulation result, and accumulating top N+1 normalized values in the sorting result to obtain a second accumulation result, wherein N is an integer greater than or equal to 1; and
obtaining an initial preset loss value based on the first accumulation result and the second accumulation result, and inverting the initial preset loss value to obtain the current preset loss value.

3. The LLM training method according to claim 2, wherein the accumulating top N normalized values in the sorting result to obtain a first accumulation result, and accumulating top N+1 normalized values in the sorting result to obtain a second accumulation result comprises:
selecting the top N normalized values in the sorting result to obtain a first target sorting result, and selecting the top N+1 normalized values in the sorting result to obtain a second target sorting result;
determining whether the first target sorting result and the second target sorting result contain a normalized value greater than the current preset loss value; and in response to that the first target sorting result and the second target sorting result contain the normalized value greater than the current preset loss value, removing the normalized value greater than the current preset loss value, and obtaining a new first target sorting result and a new second target sorting result; and
summing all normalized values in the new first target sorting result to obtain the first accumulation result, and summing all normalized values in the new second target sorting result to obtain the second accumulation result.

4. The LLM training method according to claim 2, wherein the obtaining an initial preset loss value based on the first accumulation result and the second accumulation result comprises:
subtracting the second accumulation result from the first accumulation result, and obtaining the initial preset loss value.

5. The LLM training method according to claim 1, wherein the re-selecting new corpus data from the corpus data training set comprises:
selecting, from the corpus data training set to be trained, corpus data that has not been trained; or
selecting, from corpus data whose loss value is less than the current preset loss value, corpus data that meets a second preset condition.

6. An LLM training apparatus, comprising:
an acquisition module configured to acquire a corpus data training set to be trained, and select corpus data from the corpus data training set;
a loss value calculation module configured to input the corpus data into an LLM for prediction, obtain a prediction result, calculate a current loss value by using a cross-entropy loss function based on the prediction result, save the current loss value, and calculate a current preset loss value based on the saved current loss value;
a first determination module configured to determine whether the current loss value is less than the current preset loss value; and in response to that the current loss value is less than the current preset loss value, skip updating model parameters of the LLM;
a second determination module configured to: in response to that the current loss value is greater than the current preset loss value, update the model parameters of the LLM based on the current loss value, re-select new corpus data from the corpus data training set, continue to update the model parameters of the LLM based on the new corpus data until updated model parameters meet a first preset condition, and obtain a trained LLM;
a collection module configured to collect a voice signal from a user;
an input module configured to input the voice signal into the trained LLM, and obtain a voice recognition result; and
a control module configured to control a rehabilitation device to start a limb rehabilitation exercise mode corresponding to the voice recognition result.

7. The LLM training apparatus according to claim 6, wherein the loss value calculation module comprises a selection unit, a normalization unit, an accumulation unit, and a calculation unit, wherein
the selection unit is configured to calculate, based on a plurality of saved loss values, a value of an exponential function for each of the plurality of loss values, and obtain a plurality of values;
the normalization unit is configured to perform a normalization operation on each of the plurality of values, obtain a normalized value corresponding to each of the plurality of values, sort all normalized values in a descending order, and obtain a sorting result;
the accumulation unit is configured to accumulate top N normalized values in the sorting result to obtain a first accumulation result, and accumulate top N+1 normalized values in the sorting result to obtain a second accumulation result, wherein N is an integer greater than or equal to 1; and
the calculation unit is configured to obtain an initial preset loss value based on the first accumulation result and the second accumulation result, and invert the initial preset loss value to obtain the current preset loss value.

8. The LLM training apparatus according to claim 7, wherein the accumulation unit comprises a sorting subunit, a screening subunit, and a sorting result accumulation subunit, wherein
the sorting subunit is configured to select the top N normalized values in the sorting result to obtain a first target sorting result, and select the top N+1 normalized values in the sorting result to obtain a second target sorting result;
the screening subunit is configured to determine whether the first target sorting result and the second target sorting result contain a normalized value greater than the current preset loss value; and in response to that the first target sorting result and the second target sorting result contain the normalized value greater than the current preset loss value, remove the normalized value greater than the current preset loss value, and obtain a new first target sorting result and a new second target sorting result; and
the sorting result accumulation subunit is configured to sum all normalized values in the new first target sorting result to obtain the first accumulation result, and sum all normalized values in the new second target sorting result to obtain the second accumulation result.

9. A computer device, comprising:
a memory configured to store a computer program; and
a processor configured to execute the computer program to implement the LLM training method according to claim 1.

10. A computer device, comprising:
a memory configured to store a computer program; and
a processor configured to execute the computer program to implement the LLM training method according to claim 2.

11. A computer device, comprising:
a memory configured to store a computer program; and
a processor configured to execute the computer program to implement the LLM training method according to claim 3.

12. A computer device, comprising:
a memory configured to store a computer program; and
a processor configured to execute the computer program to implement the LLM training method according to claim 4.

13. A computer device, comprising:
a memory configured to store a computer program; and
a processor configured to execute the computer program to implement the LLM training method according to claim 5.

14. A non-transitory computer-readable storage medium, wherein the non-transitory computer-readable storage medium stores a computer program, and the computer program is executed by a processor to implement the LLM training method according to claim 1.

15. A non-transitory computer-readable storage medium, wherein the non-transitory computer-readable storage medium stores a computer program, and the computer program is executed by a processor to implement the LLM training method according to claim 2.

16. A non-transitory computer-readable storage medium, wherein the non-transitory computer-readable storage medium stores a computer program, and the computer program is executed by a processor to implement the LLM training method according to claim 3.

17. A non-transitory computer-readable storage medium, wherein the non-transitory computer-readable storage medium stores a computer program, and the computer program is executed by a processor to implement the LLM training method according to claim 4.

18. A non-transitory computer-readable storage medium, wherein the non-transitory computer-readable storage medium stores a computer program, and the computer program is executed by a processor to implement the LLM training method according to claim 5.
